(19) United States
(12) Patent Application Publication
(10) Pub. No.: US 2022/0390239 A1
(43) Pub. Date: Dec. 8, 2022

(54) MULTI-LANE ROAD CHARACTERIZATION AND TRACKING ALGORITHMS

(71) Applicant: ClearMotion, Inc., Billerica, MA (US)

(72) Inventors: John Parker Eisenmann, Burlington, MA (US); William Graves, Somerville, MA (US); Yu Jiang, Wellesley, MA (US); Marcus Joseph Proctor, Goffstown, NH (US); Jack A. Ekchian, Belmont, MA (US)

(73) Assignee: ClearMotion, Inc., Billerica, MA (US)

(21) Appl. No.: 17/773,676

(22) PCT Filed: Nov. 3, 2020
(86) PCT No.: PCT/US2020/058730

§ 371 Date: May 2, 2022

Related U.S. Application Data
(60) Provisional application No. 62/930,525, filed on Nov. 4, 2019.

(51) Int. Cl. G01C 21/30; B60W 40/06

(52) U.S. Cl. CPC G01C 21/30; B60W 40/06

(57) ABSTRACT

Embodiments related to methods and systems for localizing a vehicle on a road surface are described. In some embodiments, linked reference landmarks present on the road surface may be used to determine a location of a vehicle on the road surface and/or to predict a path of travel of the vehicle along the road surface.

### CROSS-REFERENCE TO RELATED APPLICATIONS

This application claims the benefit under 35 U.S.C. § 119(e) of U.S. provisional application Ser. No. 62/930,525, filed Nov. 4, 2019, the disclosure of which is incorporated by reference in its entirety.

### FIELD

Disclosed embodiments are related to multi-lane road characterization, tracking algorithms, and related systems.

### BACKGROUND

Some types of advanced vehicle functions including, for example, autonomous or semiautonomous driving features (e.g., autonomous steering systems, active and semi-active suspension systems, etc.) may rely on systems and methods capable of accurate, high resolution, and repeatable localization of a vehicle on a road surface.

### SUMMARY

In one embodiment, a method of localizing a vehicle includes: sensing one or more parameters associated with a road surface of a road the vehicle is traversing; identifying a first reference landmark on the road the vehicle has encountered using the sensed one or more parameters; identifying a second reference landmark on the road linked to the first reference landmark; and predicting that the vehicle will traverse a portion of the road surface extending between the first reference landmark and the second reference landmark.

In one embodiment, a method of localizing a vehicle includes sensing one or more parameters associated with a road surface of a road the vehicle is traversing; identifying a first reference landmark on the road the vehicle has encountered based at least partly on the sensed one or more parameters; continuing to sense the one or more parameters as the vehicle traverses the road surface; and comparing the one or more parameters only with information related to a portion of the road surface inclusively extending between the first reference landmark and at least one reference landmark linked with the first reference landmark to determine a position of the vehicle on the road surface.

In one embodiment, a vehicle includes one or more sensors configured to sense one or more parameters associated with a road surface of a road the vehicle is traversing, and a processor operatively coupled to the one or more sensors. The processor may be configured to: sense the one or more parameters associated with the road surface as the vehicle is traversing the road; identify a first reference landmark on the road the vehicle has encountered using the sensed one or more parameters; identify a second reference landmark on the road linked to the first reference landmark; and predict that the vehicle will traverse a portion of the road surface extending between the first reference landmark and the second reference landmark.

In one embodiment, a vehicle includes one or more sensors configured to sense one or more parameters associated with a road surface of a road the vehicle is traversing, and a processor operatively coupled to the one or more sensors. The processor may be configured to: sense one or more parameters associated with a road surface of a road a vehicle is traversing; identify a first reference landmark on the road the vehicle has encountered based at least partly on the sensed one or more parameters; continue sensing the one or more parameters as the vehicle traverses the road surface; and compare the one or more parameters only with information related to a portion of the road surface inclusively extending between the first reference landmark and at least one reference landmark linked with the first reference landmark to determine a position of the vehicle on the road surface.

In one embodiment, a method of generating a roadmap includes: determining if each vehicle of a plurality of vehicles that traverse a road surface encounter a plurality of reference landmarks; determining a path of travel that each vehicle takes relative to the plurality of reference landmarks to identify links between the plurality of reference landmarks; generating a mesh of the plurality of reference landmarks and the links extending between the plurality of reference landmarks; and storing the mesh in a non-transitory processor readable memory for future recall and/or use.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic representation of one embodiment of a vehicle;

FIG. 2 is a schematic representation of one embodiment of a processor operatively coupled to various exemplary systems of a vehicle;

FIG. 3 depicts different possible common lanes that may be associated with travel along a road including two parallel lanes according to one embodiment;

FIG. 4 depicts a schematic arrangement of different reference landmarks disposed along a length and width of the road surface according to one embodiment;

FIG. 5 depicts an exemplary mesh of a plurality of linked reference landmarks associated with a road profile of a road surface according to one embodiment;

FIG. 6 depicts a schematic arrangement of different reference landmarks disposed along a length and width of the road surface according to one embodiment;

FIG. 7 is a schematic diagram of one embodiment of a method for generating a roadmap including a road profile with a mesh including linked reference landmarks; and

FIG. 8 is a schematic diagram of one embodiment of a method for determining a location of a vehicle using linked reference landmarks.

### DETAILED DESCRIPTION

As noted above, certain vehicle systems may use localization data related to a location of a vehicle on a road surface. However, the inventors have recognized that roads with multiple driving lanes (referred to herein as “multi-lane roads”) may present additional problems for a variety of localization systems. For example, it may be desirable for a multi-lane road to localize a location of the vehicle in two dimensions relative to the road surface. In one such example, it may be desirable to localize the position of a vehicle on the road surface both longitudinally (e.g., “three hundred feet from mile marker 4 on interstate 85”) as well as laterally (e.g., “in the middle lane of a three lane road”). Conventional Global Navigation Satellite System (GNSS), such as GPS, is generally not precise enough for resolving specific lanes of a multi-lane road. Additionally, the inventors have recognized that while specialized differential GNSS sensors and/or highly specialized camera systems could be used to locate a vehicle's position on a road surface more accurately, these systems increase cost and complexity in the vehicle, and further increase the chance of failure due to environmental conditions (e.g., low visibility due to weather or time of day). Having recognized this problem, the inventors have recognized the benefits associated with various systems and methods for performing lane-specific localization in multi-lane roads, especially using road-profile based localization systems. More specifically, the inventors have recognized the benefits associated with using reference landmarks present on a road surface that may be used to localize a vehicle on a road surface. This may include, as elaborated on below, not only localization of a vehicle in a longitudinal direction along a length of a road, but also localization of the vehicle in a lateral direction on a road surface. These systems and methods may offer improved accuracy, computation efficiency, and dependability relative to typical localization systems for use in localizing a vehicle along a longitudinal and/or lateral dimension of a road surface.

While it may be desirable to localize a vehicle's lateral position on a road surface, there are various conditions that may complicate determining the vehicle's position. For example, when travelling along a multi-lane road, it is possible that a driver may change lanes for different reasons at various places. Thus, in a single drive over a mutli-lane road, the actual path traversed by a vehicle may include sections of multiple lanes. That said, generally, it is assumed that a driver at any given time is more likely to remain in their current lane than to change lanes. However, this assumption may fail for locations at which there may be a specific reason for many vehicles to switch lanes at the same location (for example, in exit lanes of a highway, where traffic may slow at certain times of day, or to avoid construction).

In addition to the above, there may be certain locations where drivers repeatedly take a path not exactly corresponding to a given lane. For example, drivers may cut corners in a turn such that the driver may drift across the lane markers associated with the individual lanes. In these cases, the actual path taken by the vehicle may differ from the “lane” defined by lane markers in the road. Therefore, it is useful to introduce a term of a “commonlane.” A commonlane, as utilized herein, may refer to a path along a road segment that is commonly traversed either by a number of vehicles, or by the same vehicle over a number of drives. Since drivers may generally follow lane markings with minimal lane changes, in certain locations the commonlanes of a road segment may overlap actual lanes. However, as discussed herein, the commonlanes of a road segment may differ from the actual lanes (as defined by lane markers) in circumstances where, for example: drivers routinely cut corners in a turn (thereby drifting across lane markings); drivers routinely change actual lanes, e.g., in order to exit from a highway and/or to avoid a semi-permanent obstruction; and/or for other appropriate reasons. However, these variations in paths that drivers may follow may complicate localizing a position of a vehicle.

In view of the above, in one embodiment, it may be desirable to determine a location of a vehicle traversing a road surface. This may include sensing one or more parameters associated with the road surface that the vehicle is traversing. The sensed one or more parameters of the road surface may be used to identify a first reference landmark on the road surface that the vehicle has encountered. After identifying the first reference landmark, the first reference landmark may be used to provide information related to a likely path of travel of the vehicle over an upcoming portion of the road surface. For example, as noted above, it is likely that a vehicle will continue in the same lane of travel unless some other event such as an offramp, obstacle, or other event associated with traveling along a road surface may be present. Accordingly, a roadmap including a plurality of linked reference landmarks may be used to determine one or more reference landmarks that are linked to the first reference landmark that has been identified as being encountered by the vehicle. Thus, by identifying one or more reference landmarks that are linked to the first reference landmark, it may be possible to predict that the vehicle will traverse a portion of the road surface extending between the first reference landmark and the one or more subsequent reference landmarks that are linked with the first landmark. This may be done iteratively such that each reference landmark that the vehicle encounters may be identified and associated with other linked reference landmarks as the vehicle travels along the road surface.

In some instances, it may be desirable to help reduce the computational resources associated with identifying a location of a vehicle on a portion of a road surface that a vehicle is traversing. In such an embodiment, a first reference landmark that a vehicle has encountered may be identified. One or more reference landmarks that are linked to the first reference landmark may then be identified as well. However, as a vehicle travels between linked reference landmarks, rather than comparing the sensed parameters associated with a road surface to information related to the entire road surface, it may be desirable to limit this comparison to a portion of the road surface extending between, and including, the linked reference landmarks. For example, this might include limiting the comparison to a specific commonlane of a multilane road. This comparison of the sensed parameters to the more limited portion of the road extending between the linked reference landmarks may continue so long as the comparison is consistent with the vehicle still being located on the portion of the road extending between the reference landmarks and other sensed vehicle parameters do not indicate that the vehicle has left the current lane. However, if the comparison indicates that the vehicle is no longer on the selected portion of the road surface and/or if the sensed vehicle parameters indicate the vehicle has departed the lane, a more general comparison of the sensed one or more parameters of the road surface may be compared more generally to a reference profile of the road surface to identify another reference landmark that may indicate a position of the vehicle on the road surface, after which the process using linked reference landmarks may begin again. Thus, the localization algorithm may transition between a more computationally expensive general localization algorithm and a less computationally expensive localization algorithm where linked reference landmarks may be used to limit the portion of a road surface reference profile being used to locate the vehicle on the road surface.

The localization methods noted in the above embodiments may be used to determine and/or predict a location of a vehicle in any desired combination of dimensions relative to a road surface. For example, in one embodiment, the localization module may be used to determine and/or predict a longitudinal position of a vehicle on a road surface. In another embodiment, the localization module may be used to determine and/or predict the lateral position of the vehicle on the road surface. In yet another embodiment, the localization module may be used to determine and/or predict a longitudinal and lateral position of the vehicle along. Thus, the methods and systems described herein may be viewed as providing an improved method for generally determining the localization of a vehicle on a surface, and in some instances, more specifically, a lateral position of the vehicle on the road surface. As used herein, a longitudinal position of the vehicle on a road surface may refer to a position of the vehicle along a length of a road. Correspondingly, a lateral position of the vehicle on the road surface may refer to a position of the vehicle along a width of a road which may correspond to a position of the vehicle relative to separate lanes located across the width of the road.

To facilitate implementation of the above noted localization modules, it may be desirable to provide a roadmap including the linked reference landmarks located along a particular road surface. For example, in some embodiments, a roadmap may be generated based on information aggregated from a plurality of vehicles that traverse a particular road. This information may either be provided by a single vehicle traversing a particular portion of a road multiple times and/or from multiple vehicles traversing the same portion of the road as the disclosure is not limited in this fashion. In either case, the obtained information may be used to form a reference profile of the road surface which may be analyzed to determine the presence of one or more reference landmarks on the road surface as detailed further below. After identifying the separate reference landmarks, it may be determined whether or not each vehicle that traverses the road surface encounters the various reference landmarks. In some embodiments, this may be done by comparing parameters associated with the road surface to the reference profile for each vehicle that traverses the road surface. A path of travel of each vehicle relative to the plurality of reference landmarks may be determined to identify links extending between the plurality of reference landmarks. For example, a vehicle may have a path of travel that extends along a path including a subset of the plurality of reference landmarks. The reference landmarks that are included along the path of travel may be subsequently linked with one another. This process may be continued for each vehicle to aggregate this information to generate mesh of the reference landmarks that are linked with one another. The mesh may include the plurality of reference landmarks and the links extending between the reference landmarks. To facilitate the use of a roadmap including the mesh, the roadmap and associated mesh may be stored in a non-transitory processor readable memory for future recall and/or use as described further herein.

Due to the difficulties associated with sensing and reacting to road features present on a road surface during operation of the vehicle in real time, it may be desirable in some embodiments, to control one or more systems of the vehicle based on previously recorded information related to the road surface to improve response times and/or to proactively control the one or more systems based on previously recorded information related to the road surface. For example, as described above, it may be possible to determine a current location of the vehicle on a road surface using reference landmarks. Additionally, one or more reference landmarks present in an upcoming portion of the road surface may be linked with a reference landmark previously encountered by the vehicle. Thus, information, such as a reference road profile, related to either the upcoming reference landmarks and/or a portion of the road surface extending between the linked reference landmarks may be used to control one or more systems of the vehicle without relying solely on real-time measurements to determine one or more operating parameters of these systems as described further below. For instance, one or more operating parameters may be set prior to encountering a particular road feature on the road surface to provide improved operation of the vehicle system when traversing the upcoming portion of the road surface and/or the one or more systems may be operated based on an expected input to the vehicle from the one or more road features located along the portion of the road surface extending between the linked reference landmarks prior to sensing the road feature.

In some embodiments, road profile matching may be used to determine a location of a vehicle on a road surface with the various systems and methods described herein. As described more fully in international patent application No. PCT/US2020/023610 (published as WO 2020/191188), U.S. application Ser. No. 16,130,311 (published as US 2019/0079539), and U.S. patent application Ser. No. 16/672,004 (published as US 2020/0139784), which are incorporated herein by reference in their entirety for all purposes, road profile generation and matching is a high precision localization method for determining a location of a vehicle on a road surface. An exemplary method of road-profile based localization may operate by, for example, first collecting a reference road profile using sensors to sense one or more parameters associated with the road surface such as forces and/or motions input into one or more portions of the vehicle by the road surface, height variations of various portions of vehicle relative to the road surface, optical sensors such as laser displacement sensors, laser velocity doppler transducers (LVDTs), lidar sensors, radar sensors, and/or any other appropriate input parameter. From the reference road profile, a number of distinctive features (e.g., a distinct series of bumps) may be identified, referred to herein as reference landmarks. Appropriate methods for identifying these reference landmarks in the reference road profile may include, for example, comparing small sections of the road profile to all other sections within a given region, and identifying the ones that are least correlated to others (i.e. that are more unique). Each reference landmark may be associated with a particular absolute or relative location along the road surface. For instance, this location on the road surface may include lateral and/or longitudinal position information relative to the road surface. These reference landmarks and associated location data may be stored in a reference road profile. When a vehicle subsequently traverses a given road surface for which a reference road profile is available, a measured road profile corresponding to one or more parameters that are sensed by one or more sensors of the vehicle may be recorded as the vehicle traverses the road surface. This measured road profile may then be compared with the reference landmarks stored in the reference road profile. When a “match” occurs, that is, when the vehicle traverses a road feature located on the road surface that has been previously identified as a reference landmark, the location of the vehicle may be determined using the known location of the reference landmark. Again, international patent application PCT/US2020/023610 describes various exemplary systems and methods for: identifying reference landmarks; generating and storing reference road profiles including the reference landmarks, and comparing the measured road profiles to the reference road profiles to determine a location of a vehicle.

In some embodiments each reference landmark may include lateral position information relative to a road surface (e.g. the reference landmarks may be lane specific). For lane identification, each reference landmark may be sufficiently distinct not only longitudinally along a particular road but also laterally within the road. For example, a reference landmark may be, for example, a pothole, a storm grate, manhole cover, or other road feature that is present only in a specific lane and not in adjacent lanes. Such landmarks may allow for precise lateral localization, since a vehicle traverses a road feature associated with a particular lateral position or lane may make it relatively simply to determine the current lateral position or traveling lane of the vehicle. Even more precise lateral localization may be achieved by measuring wheel specific road-profiles. For example, if only the right wheels of a car traverse a reference landmark, then the lateral location of the vehicle's wheels within a road may be more precisely determined.

It should be noted that road profiles may change over time (e.g., due to repaving of a road, development of potholes in a road, etc.). However, this presents difficulties when trying to implement such a localization method since the identification and prediction of linked reference landmarks may be inaccurate due to changes in the road surface. Accordingly, in some embodiments, reference road profiles and reference landmarks along a road surface may be updated over a given time period. For example, a given vehicle may traverse the same road surface multiple times in a given time period (for instance, a person commuting to and from work, or a delivery van driver may drive along the same set of road surfaces multiple times per week). Additionally, multiple vehicles may traverse the same road surface during a given time period. By collecting the road profile data as multiple vehicles traverse a given road surface one or more times (e.g., ‘crowd sourcing’ from multiple vehicles), or by measuring the road profile each time a given vehicle traverses a given road surface, changes in the road's profile may be accounted for as described herein. Additionally, the characteristic signals included in the road profiles associated with the various reference landmarks may be updated using this aggregated data to either change the reference information associated with the different reference landmarks, add new reference landmarks, and/or to remove reference landmarks that are no longer present on the road surface. This information may then be used to update the links between different reference landmarks present on the road surface as elaborated on further below.

In certain embodiments, each reference landmark in a reference road profile may be associated with a level of confidence. A road profile may be measured each time a vehicle traverses a given road. In some embodiments, when a measured road profile has features that match a given reference landmark, the level of confidence associated with the given reference landmark may be increased. On the other hand, each time a subsequent measured road profile has features that fail to match a given reference landmark, the level of confidence associated with the given reference landmark may be decreased. In certain embodiments, once the level of confidence associated with a given reference landmark falls below a threshold value, it may be removed from the reference road profile altogether. For example, if a reference road profile contains a reference landmark corresponding to a pothole, or other road feature, but a sufficient number of vehicles travelling along the associated road fail to detect the reference landmark, then it may be assumed that the corresponding pothole, or other road feature, no longer exists (e.g., a municipality has repaired it). A sufficient number may be selected by the system designer, operator, or owner based on many factors, for example the typical operating information related to a specific portion of a road such as daily average traversals by vehicles, or the time between recent traversals, or average and typical speeds for the road segment compared to individual speeds of recent traversals, and other considerations such as for example weather conditions and driver behavior as inferred from steering and accelerator input signals, for example. Under such circumstances, it may be desirable to remove the corresponding reference landmark from the reference road profile once it is determined that the reference landmark is no longer present.

As noted above, road profiles including a plurality of reference landmarks may change over time. In addition to removing reference landmarks that are no longer present, it may also be desirable to add new reference landmarks that are introduced to a road profile over time. For example, in certain embodiments, a measured road profile may be added to a reference road profile of a given road to produce an updated reference road profile. For example, if a particular measured road profile substantially diverges from the existing reference road profile (that is, if road features within the particular measured road profile fail to correspond to the reference landmark included in a reference road profile), then new reference landmarks may be identified within the measured road profile. These new reference landmarks may be added to the reference road profile, to create an updated road profile that contains both the previous reference landmarks and the new landmarks.

In some embodiments, a reference profile may comprise a two dimensional mesh of reference landmarks, rather than simply a linear series of reference landmarks. For example, a reference road profile for a multi-lane road that contains multiple potential parallel paths may comprise a mesh of landmarks, wherein the dimension of the mesh corresponds to the number of lanes in the road. In certain cases, the dimension of the mesh may even exceed the number of lanes in the road, since, for example, it is possible for vehicles to drive in two different paths within the same physical lane (e.g., when some vehicles are preparing to exit a highway while others stay within their lane to continue on).

A road feature as used herein may correspond to any feature on a road surface that results in a force input to a portion of the vehicle or may otherwise be sensed by one or more sensors or systems that may provide an input to a localization module of the vehicle. While the current disclosure is not limited to any particular type of road feature, appropriate types of road features that may be considered using any of the methods and systems disclosed herein may include, but are not limited to, potholes, manhole covers, storm grates, expansion joints, frost heaves, a crest of a hill, overall surface roughness of a road surface, cracks, road swells, banked turns, drainage ditches, and/or any other appropriate feature on a road surface that results in a relevant force input to a portion of a vehicle, or other feature of the road that may be measured by the vehicle while traversing a road surface. Correspondingly, appropriate types of sensors that may be used to sense one or more parameters associated with a road surface may include, but are not limited to, accelerometers, height sensors, force sensors, outputs from a suspension system of a vehicle, but can also include non-contact distance sensors such as laser, lidar, or radar or vision-based sensors such as stereo cameras. Thus, it should be understood that the current disclosure is not limited to only the specific type of road features or method of detecting the presence of those road feature described herein as the disclosure is not limited in this fashion.

The systems and methods described herein may obtain information related to an upcoming portion of a road surface using information, such as road profiles including a plurality of reference landmarks that may be included in a roadmap. For example, the road profiles included in the roadmap may include information related to both a location, direction(s) of travel across a road surface in addition to information such as height variations, sensed accelerations applied to a vehicle while traversing the road surface, measured distance between vehicle components and the road surface, measured distance between vehicle components and external features such as road markings or road signs, and/or any other appropriate parameter that may be associated with a road surface. For example, height variations or expected accelerations along one or more lanes of travel on a road surface may be included in a roadmap. Additionally, depending on the embodiment, the information included in the road profile may be provided in any number of different formats including reference to a spatial domain, a spatial frequency domain, a temporal domain, and/or any other appropriate method of associating the reference information associated with a particular portion of a road with the sensed information from a vehicle traversing the road.

Regardless of the specific information included in a roadmap, the roadmap may be provided to a vehicle in a number of ways. For example, in one embodiment, the roadmap may be stored on non-transitory processor readable memory included on board a vehicle. Alternatively, a roadmap may be uploaded to a buffer on the vehicle from a remote database using any appropriate wireless communication method. Thus, a relevant portion of a roadmap surrounding a location of a vehicle, and/or along a path of travel of a vehicle, may be included in the buffer for use by one or more processors of the vehicle. As the vehicle traverses the road surface, the portion of the roadmap uploaded to the buffer may be correspondingly updated to ensure that a desired portion of a road surface along an upcoming portion of the road surface may be included in the buffer.

In view of the above, it should be understood that the types of information included in a roadmap and/or the manner in which a roadmap is provided to a vehicle is not limited to any specific implementation.

The information included in a roadmap may also be collected in any appropriate fashion. For example, in some embodiments data related to one or more reference landmarks, such as one or more reference profiles, may be recorded along a road surface being mapped using real-time detection with on vehicle sensors. These sensors may include, but are not limited to, accelerometers and position sensors on the vehicle, in order to record inputs from the road surface. In some embodiments, other sensors such as Lidar, Radar, optical based sensors, and/or any other appropriate sensor capable of measuring one or more parameters related to the road surface and/or a location of the vehicle relative to a road surface may be used. Additionally, localization systems capable of determining a location of a vehicle on a road surface during recordation of the parameters associated with a road surface to the vehicle may be used. For example, GNSS data, differential based GNSS data, real-time kinematic GNSS data, terrain based localization systems, dead reckoning, Kalman filters, and/or any other appropriate localization system may be used to determine an absolute location of a vehicle on a road surface associated with the detected information. In some embodiments, the recorded information may come from a single vehicle, or other source, or the recorded information may come from a crowd-sourced roadmap where information related to a particular road surface is recorded by a plurality of vehicles traversing that road surface and aggregated to generate an aggregated roadmap. However, the current disclosure is not limited to the use of roadmaps generated in such a manner. Alternatively, in some embodiments, the road features and related information included in a road map may be obtained from other information sources including known or static road profiles. For instance, a roadmap may be generated by any other appropriate method including, but not limited to, laser road scanning, camera-based road mapping, and ground-penetrating radar to name a few.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

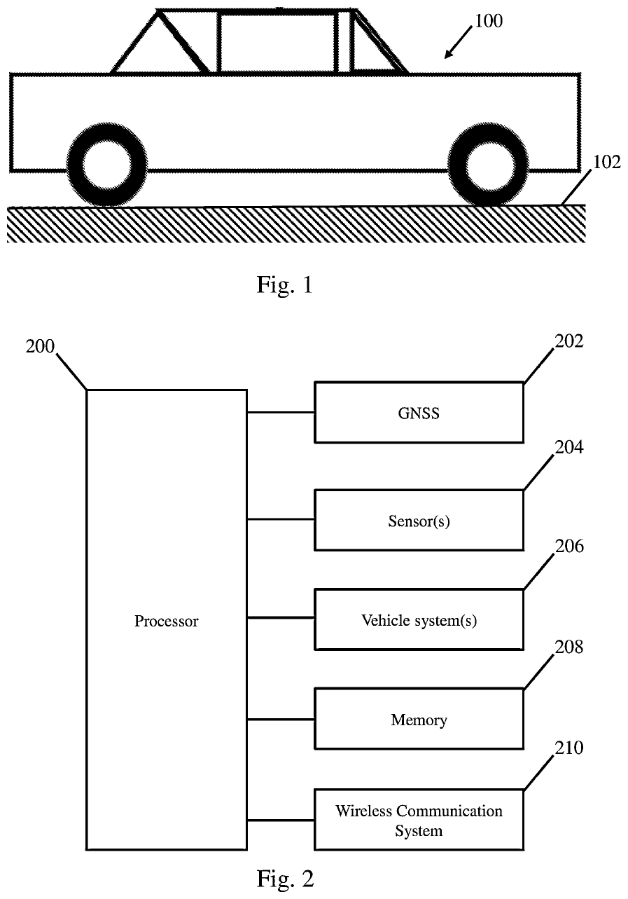

FIG. 1 depicts a vehicle 100 traversing a road surface 102 which may include a plurality of road features, which may be characterized as one or more reference landmarks. In some embodiments, the vehicle may include various sensors and control systems as depicted in FIG. 2. In the depicted figure, a vehicle may include one or more processors, such as the depicted processor 200. The processor may be operatively coupled with an optional general localization system such as the depicted GNSS system 202 which may be used to provide a general location of the vehicle. The system may also include one or more sensors 204, one or more vehicle systems 206, non-transitory processor readable memory 208, and in some embodiments a wireless communication system 210 that are operatively coupled with the processor. Appropriate types of sensors may include, but are not limited to: a speedometer output of a vehicle; a velocity sensor, shaft encoders; systems that are not typically considered sensors, but may output relevant information to the processor including steering inputs, braking inputs, height outputs from suspension systems, velocity measurements from suspension systems, acceleration sensors, non-contact displacement sensors such as laser, Lidar, or Radar; and/or any other appropriate type of sensor or device included in a vehicle that may output a desired signal to the processor for use in the methods and systems described herein. For example, the one or more sensors may sense one or more parameters associated with a road surface the vehicle is traversing. In embodiments where information, such as a buffered roadmap, is communicated to a vehicle, the wireless communication system may transmit information between the processor and one or more remote databases and/or servers. The memory associated with the one or more processors may include processor executable instructions that when executed cause the processor and the associated systems to perform any of the methods described herein. Depending on the embodiment, the processor may be a central processor of the vehicle, one or more processors associated with a localization system, one or more processors associated with a separate system included in a vehicle, combinations of the foregoing, and/or any other appropriate processor as the disclosure is not limited to where a processor used to execute the disclosed methods is located.

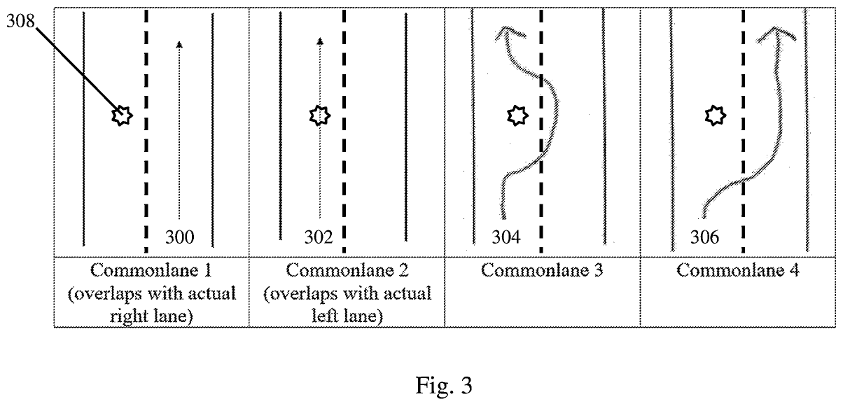

FIG. 3 illustrates the concept of commonlanes applied to vehicles traveling across an exemplary road segment. All numbers used with regard to FIG. 3 are exemplary and for illustration purposes only. In the illustrated example, the exemplary road segment has two actual lanes, as illustrated by the dashed lane divider extending between the two separate lanes as a vehicle traverses the indicated road segment. Further, the left lane of the road segment contains a pothole 308. Of the 100 vehicles that traverse the road segment, 54 start in the left lane and 46 start in the right lane. The path traversed is as follows: (i) 25 start in the left lane and stay in the left lane, traversing the pothole; (ii) 15 start in the left lane, change to the right lane to avoid the pothole, then return to the left lane; (iii) 10 start in the left lane, change to the right lane to avoid the pothole, then stay in the right lane; (iv) 46 start in the right lane and stay in the right lane. The remaining four vehicles took some random path that was not repeated by any other vehicles. Thus, while the road segment contains only two actual lanes, there are four different commonlanes, as shown in the figure corresponding to: the first commonlane 300 that follows the right lane; the second commonlane 302 that follows the left lane; the third commonlane 304 that avoids the pothole by switching to the right lane and returning to the left lane; and the fourth commonlane 306 that avoids the pothole by switching to the right lane and staying in the right lane. Thus, it should be understood that while a two lane road has been illustrated in the figure, a road including any number of lanes extending across a width of the road may be associated with a number of different commonlanes which may be greater than or equal to the number of lanes present on the road.

In certain embodiments, commonlanes may be individualized for a given vehicle. Thus, for example, rather than referring to 100 different vehicles in the above example, the relevant commonlanes may be determined by evaluating 100 different instances that the same vehicle drove the same road segment. Alternatively or additionally, the commonlanes may even be further individualized for a given driver, so that commonlanes may be determined by evaluating the paths taken by a specific driver.

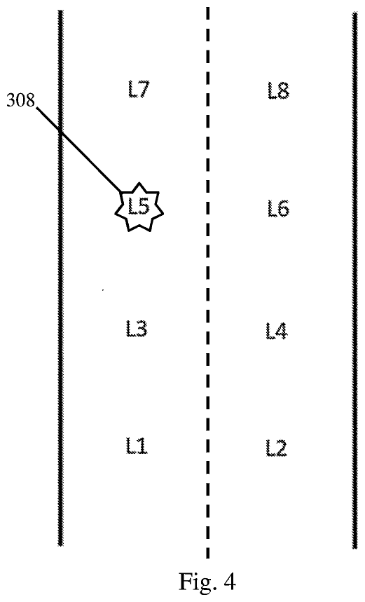

As discussed above, in some embodiments, a reference road profile associated with a particular portion of a road may comprise a mesh of a plurality of reference landmarks located at different positions along a road surface in both the lateral and longitudinal dimensions of the road surface. FIG. 4 shows an exemplary road segment that may be the same road segment as that discussed above relative to FIG. 3 overlaid with a corresponding reference road profile. The reference road profile comprises a two dimensional mesh of reference landmarks, labeled L1-L8. The illustrated road segment includes the above noted pothole 308 that is associated with reference landmark L5. For illustration purposes only, reference landmarks are shown as being regularly spaced but in reality, there may be no such restriction as the reference landmarks may have any lateral and/or longitudinal spacing between them corresponding to actual road features present on a road surface.

In this exemplary case, each commonlane shown in FIG. 3 can be thought of as a “chain” that “links” several reference landmarks together. With reference to FIG. 4, commonlane 1 may be defined by the chain of reference landmarks: L1-L3-L5-L7; commonlane 2 by the chain L2-L4-L6-L8; commonlane 3 by L1-L4-L6-L7; and commonlane 4 by L1-L4-L6-L8. That is, in certain embodiments, each reference landmark of a reference road profile may be linked to one or more other reference landmarks. These links may be established by evaluating, for example, past drives by the same vehicle, past drives by a plurality of vehicles, and/or past drives by the same driver to determine specific sequences of landmarks that were commonly traversed by a path of travel of the vehicle across the road surface.

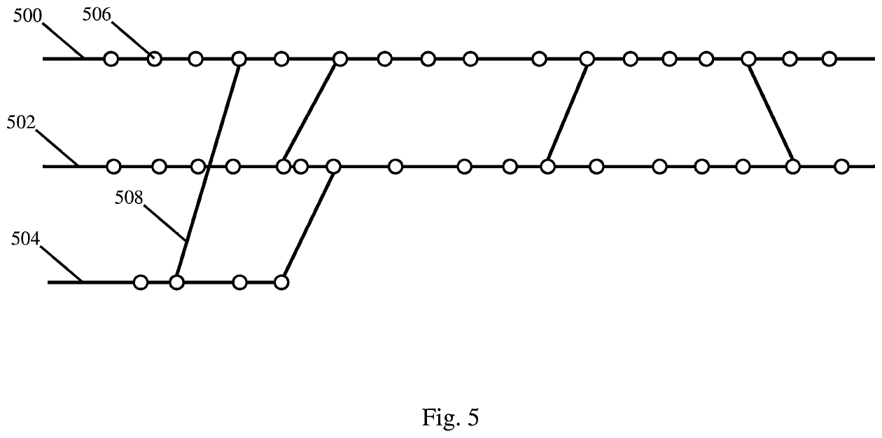

FIG. 5 illustrates a reference road profile similar to one measured for an actual reference road profile of a real road segment. The road profile was generated by measuring road profiles of a plurality of vehicles traversing the real road segment. Reference landmarks 506 were identified in the road profiles as described herein and in further detail in international patent application PCT/US2020/023610. The measured road profiles comprising the identified reference landmarks were then merged with each other to form an aggregated road map, and links 508 between successive landmarks that were associated with the actual paths of travel of the different vehicles were created. The lines between landmarks illustrate the links which were determined based on the reference landmarks that were passed in sequence along a path of travel of each vehicle. In some embodiments, the links between reference landmarks may be identified based on any vehicle traversing a path including two particular reference landmarks, a threshold number of vehicles traversing the path between two reference landmarks, a probability distribution of vehicles traversing a path between reference landmarks, a statistical analysis of vehicle traversals and the reference landmarks encountered, and/or any other appropriate method of associating two or more landmarks with one another.

As can be seen in the figure, the links extending between reference landmarks form commonlanes. Notably, defining commonlanes in this way allows for identification of likely paths without having to know any a-priori data about the number of actual lanes a particular road segment has. For example, as can be seen in the figure, the road segment started as a three lane road including first, second, and third lanes 500, 502, and 504 respectively. The third lane ended causing the road to become a two lane road as indicated by the links extending from reference landmarks 506 located in the third line to corresponding reference landmarks located in the first and second lanes. Thus, the reference road profile comprises a mesh of the plurality of illustrated reference landmarks where each landmark is linked with one or more other reference landmarks in the road profile. In some embodiments, a number of vehicles that have traversed a particular portion of a road surface corresponding to a link between two adjacent reference landmarks may be recorded over a given time period. These number of traversals of a given link may be used to either reinforce or remove a link between two reference landmarks as described further below based on an appropriate threshold or other appropriate parameter.

As noted above, in some embodiments, it may be desirable to update reference information associated with a particular portion of a road surface based on data provided by one or more vehicles that traverse the road surface over time. For example, in some embodiments, lane data may be acquired via differential GNSS, or from a specialized lane identification system that generally includes one or more specialized sensors including e.g., vehicle-mounted cameras that can identify lane markings and other waypoints, laser, radar, lidar, ground penetration scanning, road-mounted transponders, etc. If a vehicle is equipped with both a road-based localization system and a lane identification system capable of determining lane data, in certain embodiments the vehicle may simultaneously measure its road profile and lane data (e.g. a lateral position of the vehicle on a road surface) as it traverses a given road segment. A reference road profile corresponding to the road segment may then be updated such that one or more reference landmarks of the reference road profile are associated with a specific lane of the road segment. Exemplary methods for updating the reference road profile are provided above. In this way, when a second vehicle without a lane identification system subsequently traverses the road, the lane location (that is, which lane it is travelling in) of the second vehicle may be determined using only the road-based localization system, by matching its measured road profile with reference landmarks that are associated with a specific lane.

Alternatively or additionally, even if differential GNSS and/or lane identification sensor system are not available, it may still be possible to determine, or at least estimate, a lateral position of a reference landmark based on statistical analysis of historical (e.g. crowd sourced) data concerning which specific wheels encounter the reference landmark. For example, in certain embodiments, a vehicle may measure a road profile while traversing a road by using a plurality of sensors (e.g., accelerometers, suspension position sensors, or other appropriate sensor), where each sensor is associated with a particular wheel of the vehicle. In these embodiments, each wheel may measure a different road profile. For example, if a right wheel of the vehicle encounters a small pothole, but the left wheel does not encounter the pothole, then the road profile measured at the right wheel will be different than the road profile measured at the left wheel. If it is consistently observed that a particular reference landmark is only encountered by wheels on a certain side of a vehicle, or that a particular reference landmark is encountered more often by wheels on a certain side of a vehicle, lateral position data of the reference landmark may be assumed to a stronger degree of confidence. Thus, road profiles measured for multiple wheels of a vehicle may be used to provide information regarding the location of a road feature, which may be a reference landmark, relative to the vehicle.

In certain embodiments, a single road surface may be traversed multiple times by a number of different vehicles (or a single road surface may be traversed multiple times by the same vehicle). In certain embodiments, each time a given vehicle traversing the road surface encounters (or “hits”) a reference landmark, the specific wheel of the given vehicle that encountered the reference landmark may be recorded. As the reference landmark is traversed repeatedly, it is possible to determine a ratio of (a) a number of instances that the reference landmark is encountered by a right wheel of a vehicle (referred to as a “right hit”) to (b) a number of instances that the reference landmark is encountered by a left wheel of a vehicle (referred to as a “left hit”). In certain embodiments, based at least in part on a ratio, or other comparison, of right hits to left hits observed over a given time period, lateral position data and/or lane data associated with the reference landmark may be determined or estimated. This lateral position data and/or lane data may be associated with the particular reference landmark and stored in the reference road profile.

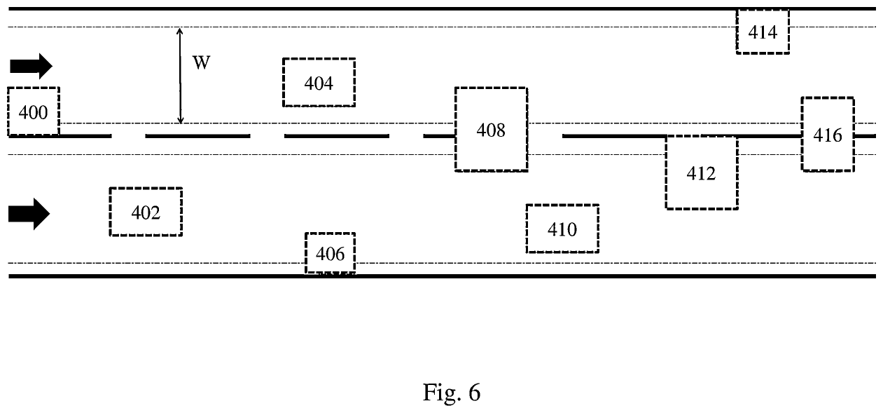

As an example, FIG. 6 illustrates an exemplary road overlaid with a plurality of reference landmarks 400-416. Initially, the longitudinal position of each reference landmark may be known (e.g. at week zero), but the lateral position (that is, which specific lane the reference landmark is located within, or where within a single lane the reference landmark is located) may not be known. For example, as reference landmark 406 is located in the rightmost portion of the right lane, it is likely that, when reference landmark 406 is encountered by any vehicle, it is only encountered by the right wheels of the given vehicle and very rarely, if ever, encountered by the left wheels of any vehicle. Over time, a comparison of the number of right to left hits for a particular reference landmark may be used to estimate a location of the reference landmark on the road surface. This may either be done using a ratio, relative percentages of hits, statistical analysis of the distribution of hits, and/or any other appropriate metric for comparing the number of hits on either side of a vehicle traversing the road surface. For example, due to a reference landmark being located to the right of the rightmost lane, over time a ratio of right hits to total hits for reference landmark 406 may approach a value close to or equal to 1, or a number greater than 0.7 but less than 1, or a number greater than 0.8 but less than 1, or a number greater than 0.9 but less than 1. Conversely, the ratio of left hits to total hits for reference landmark 414 in FIG. 6 may approach a value close to or equal to 1, or a number greater than 0.7 but less than 1, or a number greater than 0.8 but less than 1, or a number greater than 0.9 but less than 1. For a reference landmark that spans two lanes, like reference landmark 416 in FIG. 6, the ratio of right hits to total hits may approach a value near 0.5 and the ratio of left hits to total hits also approaches 0.5. As illustrated, based at least in part on historical ratios of right hits or left hits to total hits for a specific reference landmark, a lateral position or lane data of a reference landmark may be estimated. In either case, regardless of the specific metric used to perform the comparisons, in some embodiments, the measured road profiles measured by sensors associated with wheels located on either side of a vehicle may be used to determine a relative lateral location of the plurality of reference landmarks on the road surface.

Alternatively or additionally, speed data may be utilized to determine in which lane a reference landmark is located. In certain types of roads, one lane may have a higher average speed than another lane of the same road (e.g., a left lane of a freeway generally has a higher average speed than a right lane of the same freeway). In certain embodiments, a single road surface may be traversed multiple times by a number of different vehicles (or a single road surface may be traversed multiple times by the same vehicle). In certain embodiments, each time a given vehicle traversing the road surface encounters a reference landmark, an operating speed of the vehicle may be recorded. By comparing a first average operating speed of vehicles that encountered a first reference landmark with a second average operating speed of vehicles that encountered a second reference landmark, lane data for both the first and second reference landmarks may be inferred. For example, if the average operating speed of vehicles encountering landmark 404 in FIG. 6 is 75 mph and the average operating speed of vehicles encountering landmark 410 is 55 mph, then it may be inferred that landmark 404 is located in the left lane (which is generally the “fast” lane in many highways) and the landmark 410 is located in the right lane. Thus, lane data for a landmark may be determined at least in part based on historical data of the operating speed of vehicles that encounter the landmark. In some embodiments, in computing the average speed of vehicles striking a particular landmark, vehicles traveling at less than a preset threshold speed (e.g. 10%, 20%, or 30% of the speed limit) may be ignored so as to avoid counting cars when all traffic is moving at a low speed.

In some embodiments, when the lateral position of landmarks is to be determined, the system my undergo a learning phase where the interaction of vehicles with all such landmarks in a particular segment of road is monitored. Table I illustrates hypothetical results of such a learning phase. At the start of the learning process (WK 0) there have been zero left hits and zero right hits. By the end of the learning phase all reference landmarks have been hit the total number of hits and the left to right hit ratio is substantially different for many of the reference landmarks. By considering the statistics of these hits and/or the average speed at which each reference landmark is hit it may be possible determine a lateral position of one or more of the reference landmarks, and this lateral position information of the various landmarks may be incorporated into a road profile that is stored in a roadmap associated with the portion of the road including the reference landmarks. Thus, after the learning phase, a lateral location of a vehicle may be determined based at least partly on whether the vehicle's right and/or left wheels strike a given reference landmark.

TABLE I

| Number of Hits on Beacons | |
|---|---|
| WK 0 | WK 10 |

| Reference | Left | Right | Left | Right |
|---|---|---|---|---|
| Landmark | Tire Hits | Tire Hits | Tire Hits | Tire Hits |
| 400 | 0 | 0 | 30 | 100 |
| 402 | 0 | 0 | 5 | 40 |
| 404 | 0 | 0 | 40 | 5 |
| 406 | 0 | 0 | 1 | 120 |
| 408 | 0 | 0 | 120 | 100 |
| 410 | 0 | 0 | 38 | 10 |
| 412 | 0 | 0 | 120 | 90 |
| 414 | 0 | 0 | 100 | 1 |
| 416 | 0 | 0 | 115 | 105 |

In certain embodiments, GNSS or other known localization systems (e.g. GPS) may be utilized to determine a road segment over which a vehicle is traveling, but may not be able to provide specific lane data, either because the vehicle lacks a specialized lane identification system or because environmental factors (e.g., lack of visibility) precludes use of such lane identification system. In these cases, a road-based localization system may be used to identify a commonlane or actual lane in which a vehicle is travelling.

In certain embodiments the road segment over which the vehicle is travelling may be identified using GNSS or some other known localization system. In such an embodiment, the road segment may be known, but the precise location and lane is unknown. The vehicle may then measure a road profile as it traverses the road segment, and the measured profile may be compared to a reference road profile comprising a plurality of reference landmarks. If the measured profile matches one of the reference landmarks, then the vehicle may be located with an appropriate level of accuracy. In certain embodiments, a match may be considered to occur if the similarity between a portion of the measured road profile and one of the reference landmarks exceeds a threshold value. In certain embodiments, a match may be considered to occur only if (i) the similarity between a portion of the measured road profile and one of the reference landmarks exceeds a first threshold value and (ii) the similarity between the portion of the measured road profile and any other of the reference landmarks in the road segment does not exceed a second threshold value. Appropriate types of comparisons based on a threshold may include, but are not limited to, using a correlation matrix to compare the relative correlations between the road profiles, while calculating the correlation for a range of positional alignments in order to allow for small errors in the raw position signal, and/or any other appropriate comparison method as the current disclosure is not limited to a specific method for determining similarity between a measured and reference profile.

In certain embodiments, instead of looking for a match between a measured road profile and individual reference landmarks, the measured road profile may be compared with a plurality of sequences of reference landmarks, where each sequence forms a portion of a previously identified commonlane. By looking for matches with sequences of reference landmarks within a commonlane, higher levels of confidence can be obtained than when looking for matches relative to individual reference landmarks located anywhere on a road surface. For example, referring again to FIG. 4, a vehicle may be travelling on the exemplary road segment while measuring a road profile of the road surface and comparing the measured road profile to the exemplary reference road profile. In one possible example, a measured road profile of a vehicle travelling on the illustrated road segment may show a 60% similarity with landmark L3, and a 50% similarity with L8. Based on these values alone, it may not be possible to determine with sufficient confidence whether the vehicle is located at a position of L3 or a position of L8. However, if it is also determined that immediately prior, the measured road profile showed a 70% similarity with L1 and only a 10% similarity with L6. In this case, there may be higher degree of confidence that the vehicle is in fact located at the position of L3, since L1-L3 form a previously identified commonlane. Thus, the various methods and systems may use information regarding the links between different reference landmarks that form commonlanes on a road surface to determine whether or not a particular measured road profile corresponds to one or more reference landmarks on a road surface. As shown in the example above, this may be done by comparing the measured profile to multiple reference profiles located on the road surface and selecting a reference profile based at least partly on both the overall similarity of the measured road profile and reference landmark and if a particular reference landmark is linked with a reference profile that the vehicle has previously encountered.

In addition to the above, it may be computationally intensive to compare a measured road profile with every reference landmark in a given road segment. Thus, in certain embodiments, once a sufficiently precise location of a vehicle is determined, only subsequent landmarks that are in a commonlane of the identified location are compared with the measured road profile. As an example, returning again to FIG. 4, it may be determined the vehicle recently traversed reference landmark L6. In one embodiment, the subsequently measured road profile may be compared with all reference landmarks L1-L8. However, this may require substantial computing power. Alternatively, by considering the commonlanes that include L6, it may be determined that L7 and L8 are the only subsequent reference landmarks located in front of a vehicle's path of travel that are part of a commonlane including L6. Thus, it may be more computationally efficient to compare the subsequently measured road profile only with L7 and L8. Therefore, rather than comparing the measured road profile with all nearby reference landmarks, it may be more efficient to compare the measured road profile only with reference landmarks that form part of a commonlane that include a previously matched reference profile. In other words, in some embodiments, the comparison of one or more measured parameters of a road surface, such as a measured road profile, may be limited to analyzing reference landmarks that are linked to one or more reference landmarks that the vehicle has encountered. For example, the analyzed reference landmarks may be limited to reference landmarks that are linked to the last reference landmark that the vehicle has encountered. Again, this may help improve the computational efficiency and accuracy of the comparison process.

In addition to the above, it may be desirable to know what is ahead of the vehicle so that one or more vehicle systems (e.g., active suspension systems, semi-active suspension systems, steering systems, braking systems, propulsion systems) may proactively prepare (e.g., by adjusting vehicle height, suspension damping parameters, brake pressures, engine speed, and/or any other operating parameter etc.) prior to encountering various road features on the upcoming portion of the road surface. In certain embodiments, once a vehicle has been localized to a position of a given reference landmark, it may be predicted that the vehicle will follow one of the commonlanes to which the given reference landmark belongs. By predicting the path the vehicle is likely to follow based on previously identified commonlanes, vehicle systems may proactively adjust various operating parameters of one or more systems on the vehicle and/or a system may be proactively operated based on the expected inputs from the road features located along the predicted path of travel of the vehicle. For example, in certain embodiments, a path of the vehicle may be predicted and may be associated with a level of confidence. In certain embodiments, this level of confidence may be determined based at least in part on (a) the number of commonlanes to which a given reference landmark belongs, and/or (b) the number of other reference landmarks to which the given reference landmark has been linked. For example, returning to FIG. 4, the landmark L2 belongs to only one commonlane (L2-L4-L6-L8) and has been linked only to one other reference landmark, L4. On the other hand, the landmark L6 belongs to several commonlanes and has been linked to two other reference landmarks, L7 and L8. Thus, the prediction that a vehicle positioned at the landmark L2 will proceed to the position of landmark L4 may be associated with a higher level of confidence than the prediction that a vehicle positioned at landmark L6 will proceed to the position of landmark L8. Thus, in certain embodiments, control of various vehicle systems mentioned herein may be based in part on both the predicted path of the vehicle and on the level of confidence associated with such prediction. In certain embodiments, vehicle systems capable of proactive adjustment and/or operation may adjust one or more parameters only when the level of confidence associated with a predicted path exceeds a threshold value.

In some embodiments of fully active or semi-active suspension systems, information about road ahead of the vehicle may be used to prevent striking the extension and/or compression end stops of the damper. For example, based on information about the road profile ahead of a vehicle it may be determined that, at the speed the vehicle is moving forward, the anticipated vertical travel of the damper may be greater than its available range of travel. The controller may then command various controlled valves or actuators to modify certain operating parameters of the damper to avoid the striking of one or more of the end stops. Alternatively or additionally, the ride height of the vehicle may be adjusted so as to increase the available range of travel of the damper on the side (compression or extension) where additional range is needed.

In certain embodiments, lane changes or commonlane changes where a vehicle departs the current commonlane the vehicle is traveling in may be determined in one or more ways. In certain embodiments, information from one or more sensors or vehicle systems may be used to detect deviations from a path corresponding to an actual lane or a commonlane. This information may include, for example, deviations from a path given by GNSS; a vehicle yaw rate, and/or steering information that exceeds a yaw rate and/or steering input for an expected path of travel along a particular common lane (e.g. exceeding a threshold magnitude difference between the expected and actual yaw rate and/or steering input); using camera information where present to see a lane marking being crossed; and/or any other appropriate method capable of determining when a vehicle has left a particular commonlane. Alternatively or additionally, lane changes may be assumed when measured road profiles fail to match with a threshold number of expected reference landmarks. In certain embodiments, when a lane change or commonlane change is suspected for any of these reasons, the road-based localization system may restart the localization process, and, optionally, proactive adjustment of vehicle systems may be prevented until a new commonlane is identified.

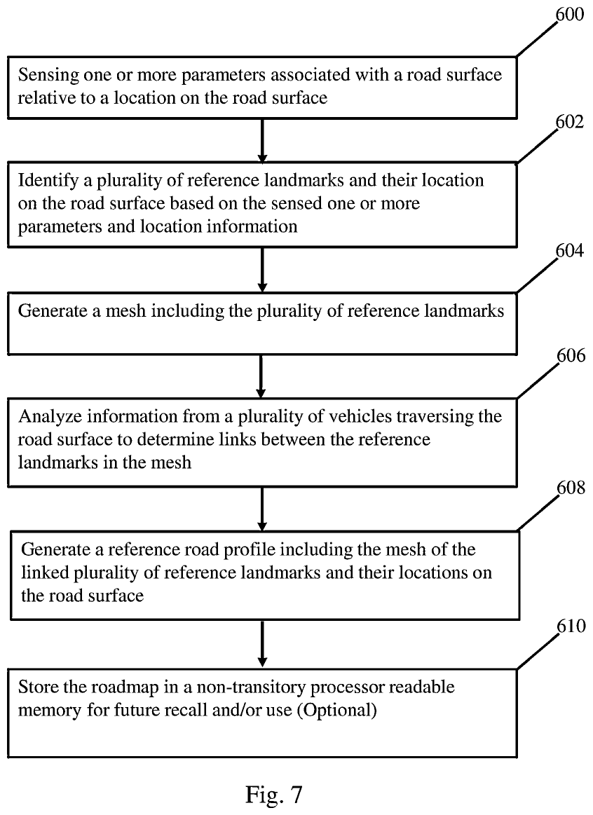

FIG. 7 illustrates one method for implementing a mapping module for providing a roadmap with the desired reference landmarks and associated links. Depending on the embodiment, the mapping module may be stored and executed at various locations, including by a processor that is associated with a central database and/or server that is remotely located from a vehicle using the resulting roadmaps. For example, a centralized database may be used to aggregate information for compiling roadmaps that may then be distributed to individual vehicles for implementing the methods described herein. However, embodiments in which the mapping module is implemented on a processor on board an individual vehicle are also contemplated as the disclosure is not so limited.

In the depicted method, one or more parameters associated with the road surface may be sensed relative to a location on the road surface at 600. As previously discussed, the road surface parameters and location data may be obtained in any number of different ways. For example, information may be aggregated from either a single, or multiple vehicles, that traverse the road surface multiple times. Alternatively, the information may be gathered using a dedicated sensing system as noted previously. In either case, an appropriate data set including the sensed parameters and location information may be provided. After obtaining the desired information, a plurality of reference landmarks and their location on the road surface may be identified using the one or more parameters of the road surface and the associated location information at 602. As noted previously, this identification of the reference landmarks may be done using any appropriate method including, but not limited to, calculating the correlation between a segment of the road profile and the landmark for a number of road profiles at different position offsets, and identifying the one with the highest correlation within a distance offset below a predetermined threshold. The identified plurality of reference landmarks and the associated locations of these reference landmarks may then be used to generate a mesh, such as a multidimensional mesh, corresponding to the longitudinal and lateral dimensions of the road surface at 604. For example, the multidimensional mesh may include a number of dimensions that is equal to or greater than a number of lanes on the road at a particular location as previously described. The mesh may include information related to the reference landmarks and the corresponding location information associated with each reference landmark.

At 606, information related to a plurality of vehicles traversing the mapped road surface may be used to determine links between the reference landmarks included in the mesh. This information may correspond to a measured road profile including appropriate sensed road inputs from sensors of the vehicle that may correspond to the one or more parameters used to characterize the reference road profile of that particular portion of the road surface. This information may either be sensed and used on board a single vehicle and/or the information may be transmitted from the one or more vehicles to one or more remotely located servers and/or databases. Regardless of where or how the information is aggregated, the measured road profiles from the multiple traversals of the road surface may be analyzed as described above to identify which reference landmarks were encountered by a vehicle, and in which order those reference landmarks were encountered. As noted previously, each traversal of a vehicle between two landmarks may be used to reinforce a relationship between those two landmarks. For example, once an association, e.g. a number of vehicle traversals, between two reference landmarks exceeds a threshold value, a link between two subsequently arranged reference landmarks may be included in the mesh. Correspondingly, in embodiments in which a roadmap is updated based on actual use data, if over time the number of vehicles traversing a section of road between two reference landmarks falls below that threshold over a given time period and/or if a threshold number of vehicles failed to identify one or both of those landmark, the link and/or reference landmarks may be removed from the mesh. However, regardless of how the specific links are generated and/or maintained over time, a mesh including the plurality of reference landmarks and links extending between those reference landmarks may be provided.

At 608, a reference road profile including the mesh of the linked plurality of reference landmarks and their locations on the road surface may be generated. In some instances, the reference road profile may simply include the one or more parameters of the road surface associated with each of the reference landmarks. However, embodiments in which portions of the road parameters associated with portions of the road surface extending between the reference landmarks are included in a reference road profile are also envisioned. Once the reference road profile has been generated, a roadmap including the reference road profile may be stored in a non-transitory processor readable memory for future recall and/or use with any of the methods and systems described herein at 610.

It should be understood that while the embodiment depicted in the figure shows a linear process for generating a roadmap including a desired reference profile with a plurality of linked reference landmarks, embodiments in which reference profiles associated with one or more sections of a roadmap are updated over time are also contemplated. For example, as previously described, information sensed by vehicles traversing the various portions of a road included in the roadmap may be used to update either the reference landmarks and/or links extending between the reference landmarks over time in some embodiments to ensure that a roadmap is current relative to the actual conditions present on the road surface. Accordingly, it should be understood that the current disclosure is not limited to the specific way that a roadmap is generated and/or maintained over time as the disclosure is not so limited.

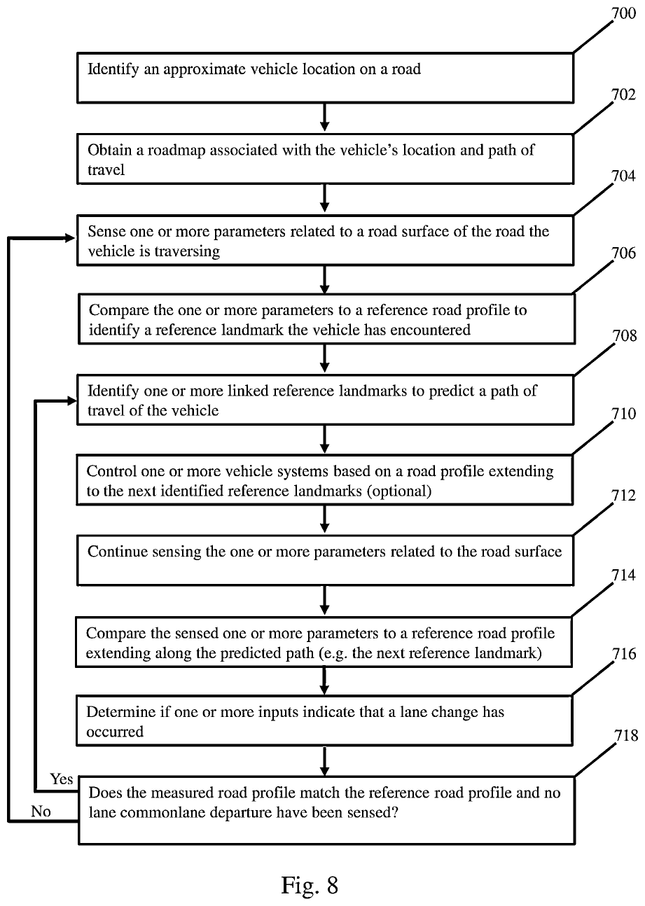

FIG. 8 shows one embodiment of a method that may be implemented by a localization module that may be used to determine a location of a vehicle on a road surface using linked reference landmarks included in a roadmap. Depending on the embodiment, the localization module may simply be used to determine a location of a vehicle on a road surface. However, embodiments in which the localization module, or an output from the localization module, is used to control one or more operating parameters and/or operation of a system disposed on the vehicle are also contemplated as detailed further below. Depending on the particular embodiment, the localization module may be stored and executed at various locations on the vehicle. This may include a central processor of the vehicle, a dedicated processor for the localization module, distributed processors associated with various systems of the vehicle, combinations of the foregoing, and/or any other appropriate arrangement as the disclosure is not limited to where or how these processes are implemented.

In the depicted embodiment, at 700 a vehicle location and path of travel along a road surface may be identified. For example, information from a localization system such as a Global Navigation Satellite System (GNSS), terrain based localization system, and/or any other appropriate localization system along with information from appropriate systems such as an autonomous vehicle control system may be used by the processor to identify an approximate location of the vehicle on the road. The processor may then obtain a roadmap including information, such as a reference road profile related to the portion of a road being traversed by the vehicle at 702. Depending on the particular embodiment, the processor may obtain the desired roadmap either by recalling it from memory, loading it into a buffer from data downloaded from a remote database and/or server to the vehicle, and/or any other appropriate method for obtaining the roadmap including the desired portion of the road surface.

At 704, a vehicle may sense one or more parameters related to the road surface of the road that the vehicle is traversing. As noted previously, the one or more parameters may correspond to any appropriate parameter capable of characterizing the road surface. This may include parameters such as accelerations, force inputs, height variations, combinations of the foregoing, and/or any other appropriate type of parameter that may be used to characterize the road surface. Additionally, the one or more parameters may be sensed using sensors, outputs from various systems of the vehicle, and/or any other appropriate device that may provide the desired input to the processor. Regardless of how the one or more parameters are sensed, the one or more sensed parameters, which may correspond to a measured road profile may be compared to a reference road profile to identify one or more reference landmarks that the vehicle has encountered at 706. This comparison may be done using any of the previously disclosed methods for comparing a measured road profile and a reference road profile or other appropriate information that may be used to characterize reference landmarks on a road surface. After identifying a reference landmark that the vehicle has encountered, one or more associated reference landmarks that are linked to the last reference landmark encountered by the vehicle may be identified at 708. For example, one or more commonlanes including the last encountered reference landmark may be identified using links included in a mesh of the reference landmarks included on the road surface. This may include identifying linked reference landmarks that are disposed ahead of the vehicle along the one or more commonlanes relative to a direction of travel of the vehicle on the road surface. These commonlanes may then be used to predict a path of travel of the vehicle on the road surface based on the linked reference landmarks. The confidence level associated with the one or more predicted paths may be a function of the number commonlanes, and the corresponding reference landmarks, that are linked to a current position of the vehicle.

In some instances, one or more systems of the vehicle may be controlled based on the predicted path of the vehicle using the road profile extending to the next identified reference landmark along the predicted path at 710. For example, one or more operating parameters of the system may be changed based on one or more upcoming road features included in a portion of the road extending along a commonlane that the vehicle is located on. Alternatively, the one or more systems may be operated to respond preemptively to one or more upcoming road features. Specific methods for operating the various systems of a vehicle based on the predicted path of the vehicle along one or more commonlanes on a road surface are described in further detail above.

In some embodiments, it may be desirable to reduce the computational cost and/or to improve accuracy associated with the use of linked reference landmarks. Accordingly, at 712, the localization module may continue to sense the one or more parameters related to the road surface to provide, for example, a measured road profile. The one or more sensed parameters of the road surface, e.g. the measured road profile, may be compared to a reference road profile extending along the one or more predicted paths (e.g. one or more commonlanes) of the vehicle at 714. For example, the measured road profile may be compared to one or more reference road profiles associated with one or more reference landmarks that are linked with a reference landmark, such as a last reference landmark, that the vehicle has encountered. This may improve both the computational cost and accuracy by limiting the comparison of the measured road profile to those reference road profiles that are associated with the one or more linked reference landmarks.

In addition to the above, in some embodiments, the system may also determine if a lane change from a commonlane that the vehicle was traveling along has occurred at 716. For example as previously described, a yaw rate greater than a threshold value for a given portion of a road surface, line sensors, steering inputs greater than a threshold value for a given portion of a road surface, and/or any other appropriate systems and/or methods may be used to determine if the vehicle has departed from a commonlane that the vehicle was traveling along.

At 718 it may be determined whether the measured road profile matches the expected reference road profile along the predicted path of travel and whether or not a lane change was detected. Assuming that the measured and predicted reference road profiles match and no lane change was detected, the process may continue with identifying subsequently encountered reference landmark and predicting a path of the vehicle using reference landmarks that are linked to the encountered reference landmarks. However, if the measured and predicted reference road profiles do not match and/or if a lane change was detected, the process may go back to step 704 where a general location of the vehicle may be determined by identifying a reference landmark encountered by the vehicle using a more general comparison to the reference road profile of a section of road the vehicle is located on at 706. The process may then continue as previously described above.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Also, a processor may be associated with one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch screens, touch pads, and digitizing tablets. As another example, a processor may receive input information through speech recognition or in other audible format.

Such processors may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a processor readable storage medium (or multiple processor readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a processor readable storage medium may retain information for a sufficient time to provide processor-executable instructions in a non-transitory form. Such a processor readable storage medium or media can be transportable, such that the program or programs stored thereon can be loaded onto one or more different computing devices or other processors to implement various aspects of the present disclosure as discussed above. As used herein, the term “processor-readable storage medium” or “processor-readable memory” encompasses only a non-transitory processor-readable medium that can be considered to be a manufacture (i.e., article of manufacture) or a machine. Alternatively or additionally, the disclosure may be embodied as a processor readable medium other than a processor-readable storage medium, such as a propagating signal.

The terms “program” or “software” are used herein in a generic sense to refer to any type of computer code or set of processor-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Processor-executable instructions may be in many forms, such as program modules, executed by one or more processors or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A method of localizing a vehicle, the method comprising:
sensing one or more parameters associated with a road surface of a road the vehicle is traversing;
identifying a first reference landmark on the road the vehicle has encountered using the sensed one or more parameters;
identifying a second reference landmark on the road linked to the first reference landmark; and
predicting that the vehicle will traverse a portion of the road surface extending between the first reference landmark and the second reference landmark.

2. The method of claim 1, further comprising comparing the one or more parameters to a reference road profile to identify the first reference landmark.

3. The method of claim 2, further comprising obtaining the reference road profile.

4. The method of claim 3, wherein the reference profile comprises a mesh of a plurality of reference landmarks located on the road surface, and wherein each reference landmark of the mesh is linked to at least one other reference landmark in the mesh.

5. The method of claim 1, further comprising determining a lateral position of the vehicle on the road surface based at least partly on a location of the first reference landmark.

6. The method of claim 1, further comprising continuing to sense the one or more parameters and comparing the one or more parameters to a reference road profile extending between the first reference landmark and the second reference landmark.

7. The method of claim 1, further comprising, prior to the vehicle encountering the second reference landmark, controlling a system of the vehicle based at least in part on one or more selected from the group of a feature of the second reference landmark and a reference road profile inclusively extending between the first reference landmark and the second reference landmark.

8. The method of claim 7, further comprising determining a level of confidence associated with the prediction, wherein the level of confidence is determined based at least in part on a total number of reference landmarks that are linked to the first reference landmark; and wherein the system of the vehicle is controlled based at least in part on the determined level of confidence.

9. A method of localizing a vehicle, the method comprising:
sensing one or more parameters associated with a road surface of a road the vehicle is traversing;
identifying a first reference landmark on the road the vehicle has encountered based at least partly on the sensed one or more parameters;
continuing to sense the one or more parameters as the vehicle traverses the road surface; and
comparing the one or more parameters only with information related to a portion of the road surface inclusively extending between the first reference landmark and at least one reference landmark linked with the first reference landmark to determine a position of the vehicle on the road surface.

10. The method of claim 9, further comprising comparing the one or more parameters to a reference road profile to identify the first reference landmark.

11. The method of claim 10, further comprising obtaining the reference road profile.

12. The method of claim 1, wherein the reference profile comprises a mesh of a plurality of reference landmarks located on the road surface, and wherein each reference landmark of the mesh is linked to at least one other reference landmark in the mesh, wherein the first reference landmark and the at least one reference landmark linked to the first landmark are part of the plurality of reference landmarks.

13. The method of claim 9, further comprising determining a lateral position of the vehicle on the road surface.

14. The method of claim 9, further comprising, prior to the vehicle encountering the at least one reference landmark linked to the first reference landmark, controlling a system of the vehicle based at least in part on one or more selected from the group of a feature of the at least one reference landmark and a reference road profile inclusively extending between the first reference landmark and the at least one reference landmark.

15. The method of claim 9, further comprising identifying the at least one reference landmark linked to the first reference landmark based at least partly on the sensed one or more parameters.

16. The method of claim 15, further comprising predicting that the vehicle will traverse a portion of the road surface extending between the first reference landmark and the at least one reference landmark linked to the first reference landmark.

17. A vehicle comprising:
one or more sensors configured to sense one or more parameters associated with a road surface of a road the vehicle is traversing;
a processor operatively coupled to the one or more sensors, wherein the processor is configured to:
sense the one or more parameters associated with the road surface as the vehicle is traversing the road;
identify a first reference landmark on the road the vehicle has encountered using the sensed one or more parameters;
identify a second reference landmark on the road linked to the first reference landmark; and
predict that the vehicle will traverse a portion of the road surface extending between the first reference landmark and the second reference landmark.

18. The vehicle of claim 17, wherein the processor is further configured to compare the one or more parameters to a reference road profile to identify the first reference landmark.

19. The vehicle of claim 18, wherein the processor is further configured to obtain the reference road profile.

20. The vehicle of claim 19, wherein the reference profile comprises a mesh of a plurality of reference landmarks located on the road surface, and wherein each reference landmark of the mesh is linked to at least one other reference landmark in the mesh.

21. The vehicle of claim 17, wherein the processor is further configured to determine a lateral position of the vehicle on the road surface based at least partly on a location of the first reference landmark.

22. The vehicle of claim 17, wherein the processor is further configured to continue sensing the one or more parameters and compare the one or more parameters to a reference road profile extending between the first reference landmark and the second reference landmark.

23. The vehicle of claim 17, wherein the processor is configured to, prior to the vehicle encountering the second reference landmark, control a system of the vehicle based at least in part on one or more selected from the group of a feature of the second reference landmark and a reference road profile inclusively extending between the first reference landmark and the second reference landmark.

24. The vehicle of claim 23, wherein the processor is further configured to determine a level of confidence associated with the prediction, wherein the level of confidence is determined based at least in part on a total number of reference landmarks that are linked to the first reference landmark; and wherein the processor is configured to control the system of the vehicle based at least in part on the determined level of confidence.

25. A vehicle comprising:
one or more sensors configured to sense one or more parameters associated with a road surface of a road the vehicle is traversing; and
a processor operatively coupled to the one or more sensors, wherein the processor is configured to:
sense one or more parameters associated with a road surface of a road a vehicle is traversing;
identify a first reference landmark on the road the vehicle has encountered based at least partly on the sensed one or more parameters;
continue sensing the one or more parameters as the vehicle traverses the road surface; and
compare the one or more parameters only with information related to a portion of the road surface inclusively extending between the first reference landmark and at least one reference landmark linked with the first reference landmark to determine a position of the vehicle on the road surface.

26. The vehicle of claim 25, wherein the processor is further configured to compare the one or more parameters to a reference road profile to identify the first reference landmark.

27. The vehicle of claim 26, wherein the processor is further configured to obtain the reference road profile.

28. The vehicle of claim 27, wherein the reference profile comprises a mesh of a plurality of reference landmarks located on the road surface, and wherein each reference landmark of the mesh is linked to at least one other reference landmark in the mesh, wherein the first reference landmark and the at least one reference landmark are part of the plurality of reference landmarks.

29. The vehicle of claim 25, wherein the processor is further configured to determine a lateral position of the vehicle on the road surface.

30. The vehicle of claim 25, wherein the processor is further configured to, prior to the vehicle encountering the at least one reference landmark linked to the first reference landmark, control a system of the vehicle based at least in part on one or more selected from the group of a feature of the at least one reference landmark and a reference road profile inclusively extending between the first reference landmark and the at least one reference landmark.

31. The vehicle of claim 25, wherein the processor is further configured to identify the at least one reference landmark linked to the first reference landmark based at least partly on the sensed one or more parameters.

32. The vehicle of claim 31, wherein the processor is further configured to predict that the vehicle will traverse a portion of the road surface extending between the first reference landmark and the at least one reference landmark linked to the first reference landmark.

33. A method of generating a roadmap, the method comprising:
determining if each vehicle of a plurality of vehicles that traverse a road surface encounter a plurality of reference landmarks;
determining a path of travel that each vehicle takes relative to the plurality of reference landmarks to identify links between the plurality of reference landmarks;
generating a mesh of the plurality of reference landmarks and the links extending between the plurality of reference landmarks; and
storing the mesh in a non-transitory processor readable memory for future recall and/or use.

34. The method of claim 33, wherein each reference landmark of the plurality of reference landmarks is linked to at least one other reference landmark of the mesh.

35. The method of claim 33, wherein the roadmap includes a reference profile of the road surface extending between the linked plurality of reference landmarks.

36. The method of claim 33, further comprising determining a confidence level associated with the paths of travel extending between the linked plurality of reference landmarks based at least in part on a number of links associated with each reference landmark.
